(19) United States
(12) Patent Application Publication
(10) Pub. No.: US 2016/0220853 A1
(43) Pub. Date: Aug. 4, 2016

(54) Compact Respiratory Protective Device

(71) Applicants: William Duncan Wood, Edinburgh (GB); Robin Middlemass Howie, Edinburgh (GB)

(72) Inventors: William Duncan Wood, Edinburgh (GB); Robin Middlemass Howie, Edinburgh (GB)

(21) Appl. No.: 14/991,656

(22) Filed: Jan. 8, 2016

Related U.S. Application Data
(63) Continuation of application No. 13/574,606, filed on Aug. 13, 2012, now abandoned.
(60) Provisional application No. 61/297,374, filed on Jan. 22, 2010.

(51) Int. Cl. A62B 23/02; A62B 7/10; A62B 9/06; A62B 17/04

(52) U.S. Cl. CPC A62B 23/02; A62B 17/04; A62B 7/10; A62B 9/06

(57) ABSTRACT

A compact respiratory protective device fitted with a mouthpiece or mouthpiece assembly that retracts, pivots or rotates into the depth of the device to reduce size when packed. This reduction in size also permits the depth of the downstream air channel to be increased while still producing a compact device. This increase in the depth of the downstream air channel maximizes the efficiency and capacity of the filter assembly and reduces the inhalation resistance of the device. The reduced breathing resistance enhances usability.

### CROSS REFERENCE TO RELATED APPLICATION

This application claims the priority of U.S. provisional Application Ser. No. 61/297,374 entitled “A NOVEL COMPACT RESPIRATORY PROTECTIVE DEVICE” filed on 22 Jan. 2010, the entire contents nd substance of which are hereby incorporated in total by reference.

### GOVERNMENT LICENSE RIGHTS

The U.S. Government has a paid-up license in this invention and the right in limited circumstances to require the patent owner to license others on reasonable terms as provided for by the terms of Contract No. W91CRB-07-0-0081 awarded by US Army RDECOM Acquisition Center.

### FIELD OF THE INVENTION

The present invention relates generally to personal protective equipment and in particular to respiratory protective devices fitted with a mouthpiece which forms an effectively airtight connection between the mouth of the wearer of the device and the filter box assembly or connection to the source of contaminant-free breathing gas.

### BACKGROUND OF THE INVENTION

A number of respiratory protective devices are fitted with mouthpieces which provide an effectively airtight connection between the mouth of the wearer of the device and the filter box assembly in filter devices or the connection to the source of contaminant-free breathing gas.

For many respiratory protective devices it is important that the stored bulk of the device is as low as possible to ensure that such devices can be carried on the person, in a handbag or briefcase or stored in large numbers close to the likely point of usage so that the devices are available when required. Devices, which are too bulky to be so carried or stored, may not be available when required, and will therefore provide no protection.

Low bulk is therefore an essential prerequisite of effective respiratory protective devices, such as for self-rescue or in industrial, commercial or mining environments.

Although mouthpiece devices are generally less bulky than equivalent devices fitted with conventional facepieces, the mouthpieces incorporated in conventional devices impact adversely on the volume of the packed device.

Therefore, it is an object of the present invention to obviate, or at least mitigate, at least some of the drawbacks associated with the prior art.

Further aims and objects of the invention will become apparent from a reading of the following description.

### SUMMARY OF THE INVENTION

Briefly described, in one aspect the invention comprises a method of reducing the packed dimensions of a respiratory protective device fitted with a mouthpiece in order to enable it (for example) to be carried unobtrusively on the person, in a briefcase, in a handbag, or stored in large numbers close to the point of likely usage. There is also described, in one aspect, a respiratory protective device fitted with a mouthpiece and having reduced packed dimensions.

According to a first aspect of the invention there is provided a respiratory protective device comprising a filter box assembly and a mouthpiece assembly, said mouthpiece assembly configured for fluid connection to said filter box assembly, wherein the mouthpiece assembly is moveable, relative to the filter box assembly, between a packed and an unpacked position, such that in the packed position the mouthpiece assembly is located at least partly within the profile of the filter box assembly, thereby reducing the size of the device.

The mouthpiece assembly may comprise a mouthpiece and other components, or may consist only of (or essentially of) a mouthpiece.

In the context of the present invention, the mouthpiece assembly is located at least partly within the profile of the filter box assembly in the packed position insofar as the mouthpiece assembly may be partly or wholly contained within the filter box assembly, or insofar as the mouthpiece assembly is located externally to the filter box assembly and is orientated to provide a partial or complete overlap with at least some of the dimensions (length, depth or width/height) of a side of the filter box assembly.

The device may comprise an air channel and a filter. As the device is very compact, the depth of the air channel can be increased or optimised without making the device unnecessarily large. Optimising or increasing the depth of the air channel improves utilisation of the filter, thus enhancing filter efficiency, and reducing breathing resistance, which maximises wearer acceptability. Furthermore, this can be achieved in a device which is small and compact enough to be conveniently carried or stored, which maximises the appeal of the device to individuals and corporations alike.

The packed position is the “not in use” or “non-use” position, and the unpacked position is the “in use” or “use” position.

The mouthpiece assembly may comprise a mouthpiece.

Typically, at east part of the mouthpiece is elastically deformable to minimise the size thereof. At least part of the mouthpiece may be foldable.

The mouthpiece is typically made from resilient elastomeric materials such as neoprene, butyl rubber or suitable silicone which can be easily folded, and which will return to their original shape.

Typically, in the packed position, a majority of the mouthpiece assembly is located within the profile of the filter box assembly. Typically, in the unpacked position, a minority of the mouthpiece assembly is located within the profile of the filter box assembly.

In one embodiment,in the packed position the mouthpiece assembly is at least partially contained within the filter box assembly.

In one embodiment, in the packed position the mouthpiece assembly is at least partially recessed into the filter box assembly.

The mouthpiece assembly may be retractably connected to the filter box assembly. The mouthpiece assembly is typically retracted in the packed position.

The mouthpiece assembly may be extendibly connected to the filter box assembly. The mouthpiece assembly is typically extended in the unpacked position.

The mouthpiece assembly may be rotatably connected to the filter box assembly.

Alternatively, the mouthpiece assembly may be pivotally connected he filter box assembly.

The device may further comprise a flexible diaphragm located between the mouthpiece assembly and the filter box assembly, said diaphragm providing a hermetic seal.

The flexible diaphragm provides a hermetic (airtight) seal between the filter box assembly and the mouthpiece or mouthpiece assembly, thus ensuring that in use air can only be breathed through the filter box assembly, and not directly from the atmosphere. As it is flexible, it allows the mouthpiece or mouthpiece assembly to move relative to the filter box assembly, whilst retaining a hermetic seal, and thus enables the mouthpiece or mouthpiece assembly to be moved from a packed to an unpacked position.

The device may further comprise a biasing means configured to move the mouthpiece assembly into the unpacked position.

The biasing means may be, for example, a spring.

Optionally, the device further comprises a first backplate attached to the mouthpiece, and a second backplate attached to the filter box assembly.

Typically, in the unpacked position, the first backplate abuts the second backplate. This fixes the mouthpiece or mouthpiece assembly in place so that the device is stable in use. The backplates move relative to each other, which enables the mouthpiece or mouthpiece assembly to extend out of the filter box assembly.

In one embodiment, the mouthpiece assembly is located externally to the filter box assembly and, in the packed position, is positioned such that at least part of the mouthpiece assembly overlaps with a side of the filter box assembly.

The mouthpiece assembly may overlap a side of the filter box assembly that is defined by the height and depth thereof.

Typically, in the packed position, the mouthpiece or mouthpiece assembly lies juxtaposed the smallest (by area) side of the filter box assembly, along the depth axis, thereby creating a substantially flat device, which is compact and easily stored or carried.

The mouthpiece assembly may be rotatable relative to the filter box assembly. Typically, the mouthpiece assembly is rotatably connected to the filter box assembly.

The device may further comprise a gasket located between the mouthpiece assembly and the filter box assembly, said gasket configured to provide a hermetic seal therebetween when the mouthpiece assembly is rotated to the unpacked position.

It is useful for the gasket to remain uncompressed until it is to be used. This is because if the gasket is stored under compression for extended periods of time it can become adhered to the mouthpiece/mouthpiece assembly or the filter box assembly. This can act to prevent rotation of the mouthpiece assembly relative to the filter box assembly, or can cause the gasket to become ruptured or otherwise structurally compromised over the passage of time, or by attempted rotation of the mouthpiece assembly relative to the filter box assembly. This can then enable leakage of unfiltered contaminants into the filter box assembly.

Alternatively, the mouthpiece assembly is pivotable relative to the filter box assembly. Typically, the mouthpiece assembly is pivotally connected to the filter box assembly.

The device may further comprise bellows located between the mouthpiece assembly and the filter box assembly, said bellows providing a hermetic seal therebetween. The bellows may form part of the mouthpiece assembly.

The filter box assembly may further comprise a filter in fluid connection with the mouthpiece assembly and configured to permit ingress of air from the atmosphere.

Typically, the filter is a longitudinal filter extending along the longest axis of the filter box assembly.

The filter box assembly may further comprise an air channel located between the filter and the mouthpiece assembly and in fluid connection therewith. Typically the air channel is a longitudinal air channel extending along the longest axis of the filter box assembly, substantially in parallel with the filter.

The air channel acts as a downstream air channel. As the device is very compact, the depth of the air channel can be increased or optimised. This improves utilisation of the filter elements, thus enhancing filter efficiency, and reducing breathing resistance, thus maximising wearer acceptability.

The filter may be configured to selectively inhibit the passage of one or more toxic substances. The filter may be configured to selectively inhibit the fluid passage of one or more toxic substances.

A toxic substance may be, for example, a gas, aerosol or particulate substance which is harmful to humans, or any substance that emits breathable toxins.

Typically, the filter is configured to selectively inhibit the passage of smoke.

Optionally the filter box assembly further comprises at least one exhalation valve configured to allow the expulsion of air from the filter box assembly, and to inhibit the ingress of air into the filter box assembly. Of course, the ingress of air is still permitted through the filter.

The exhalation valve may be a non-return valve orientated to allow air out of the filter box assembly, and to prevent air from entering the filter box assembly. Thus, the exhalation valve enables the user to exhale air directly into the atmosphere, but prevents the user from inhaling air directly from the atmosphere.

Typically, the exhalation valve is at least partially recessed into the filter box assembly.

Optionally, the device further comprises a hood. Typically, the hood is connected to the filter box around the mouthpiece assembly. Alternatively, the device can be used with a conventional noseclip as is known in the art.

According to a second aspect of the invention there is provided a respiratory protective device in which the mouthpiece can be fully or partly recessed into the downstream air channel and/or filter assembly and/or other components of the device or rotated or retracted into the depth of the device to reduce or minimize the packed volume of the device.

A device as stated in the second aspect in which the mouthpiece is rotated or extended either manually or by a suitable means when the device is unpacked for use.

A device as stated in the second aspect, and as stated in the paragraphs relating thereto, in which the downstream air channel is so configured as to maximize the utilization of the efficiency and capacity of the filter media.

A device as slated in the second aspect, and as stated in the paragraphs relating thereto, in which relative rotation of the relevant component(s) causes the means of providing an airtight seal between the fixed and rotating components to be compressed to enhance the air tightness of the seal.

A device as stated in the second aspect, and as stated in the paragraphs relating thereto, in which the exhalation valve(s) is/are recessed into the downstream air channel and/or other component of the device to reduce or minimize the packed volume of the device.

The present invention reduces the overall volume of the packed respiratory protective devce by retracting, folding, or rotating the mouthpiece into the depth of the titer box assembly. The mouthpiece is then extended when required for use.

The reduced bulk of the device permits the depth of the downstream air channel to be increased without adverse impact within a compact device. This increased depth of the downstream air channel improves utilisation of the filter elements, thus enhancing filter efficiency, and reducing breathing resistance, thus maximizing wearer acceptability.

### BRIEF DESCRIPTION OF THE DRAWINGS

There will now be described, by way of example only, embodiments of the invention with reference to the following Figures, of which:

FIG. 1 shows an end elevation in cross section B-B of FIG. 2 of a filter device in which the retractable mouthpiece is in the in-use position;

FIG. 2 shows a side elevation in cross section C-C of FIG. 1 of a filter device in which the retractable mouthpiece is in the in-use position;

FIG. 3 shows an end elevation in cross section B-B of FIG. 2 of a filter device in which the retractable mouthpiece is in the packed position;

FIG. 4 shows a plan view of a filter device in which the rotatable mouthpiece is in the pocked position;

FIG. 5 shows a side elevation of a filter device in which the rotatable mouthpiece is in the in-use position;

FIG. 6 shows an end elevation of a filter device in which the rotatable mouthpiece is in the in-use position;

FIG. 7 shows an end elevation of a filter device in which the rotatable mouthpiece is in the packed position;

FIG. 8 shows a plan view of a filter device in which the mouthpiece is connected to the filter box assembly using an airtight flexible bellows and with the mouthpiece in the packed position;

FIG. 9 shows an end elevation of a filter device in which the mouthpiece is connected to the filter box assembly using an airtight flexible bellows and with the mouthpiece in the packed position;

FIG. 10 shows an end elevation of a filter device in which the mouthpiece is connected to the filter box assembly using an airtight flexible bellows and with the mouthpiece in the in-use position;

FIG. 11 shows a plan view of a filter device in which the mouthpiece is connected to the filter box assembly using a hollow airtight axle and with the mouthpiece in the packed position;

FIG. 12 shows a side elevation of a filter device in which the mouthpiece is connected to the filter box assembly using a hollow airtight axle and with the mouthpiece in the packed position;

FIG. 13 shows a side elevation of a filter device in which the mouthpiece is connected to the filter box assembly using a hollow airtight axle and with the mouthpiece in the in-use position;

FIG. 14 shows a plan view of a filter device in which the mouthpiece is connected to the filter box assembly using an airtight bellows and with the mouthpiece in the packed position;

FIG. 15 shows a side elevation of a filter device in which the mouthpiece is connected to the filter box assembly using an airtight bellows and with the mouthpiece in the packed position; and

FIG. 16 shows a side elevation of a filter device in which the mouthpiece is connected to the filter box assembly using an airtight bellows and with the mouthpiece in the in-use position.

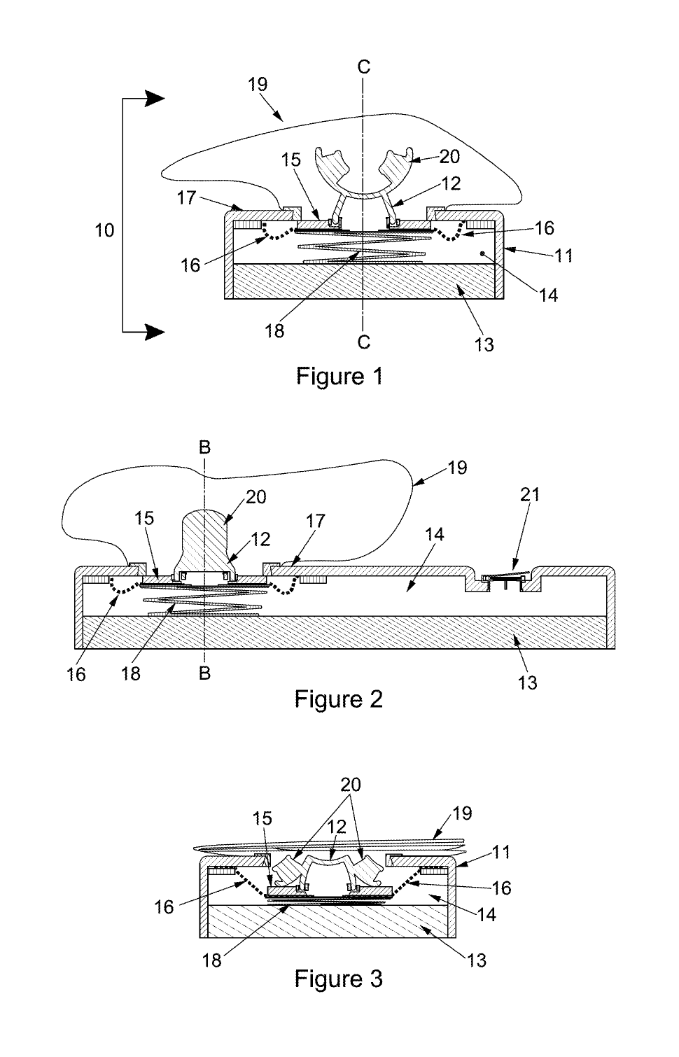

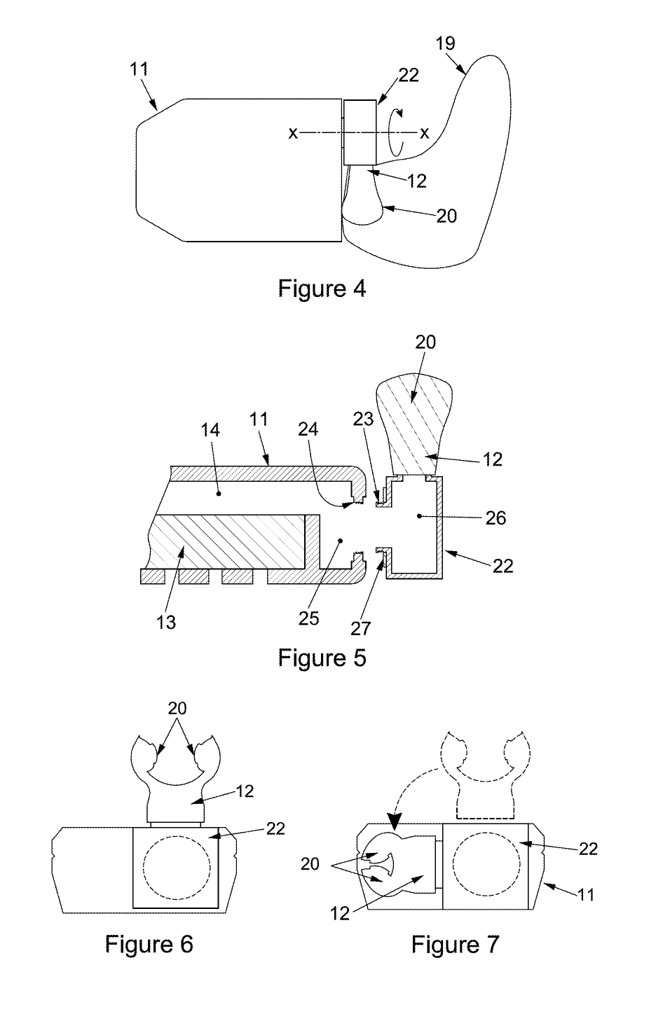

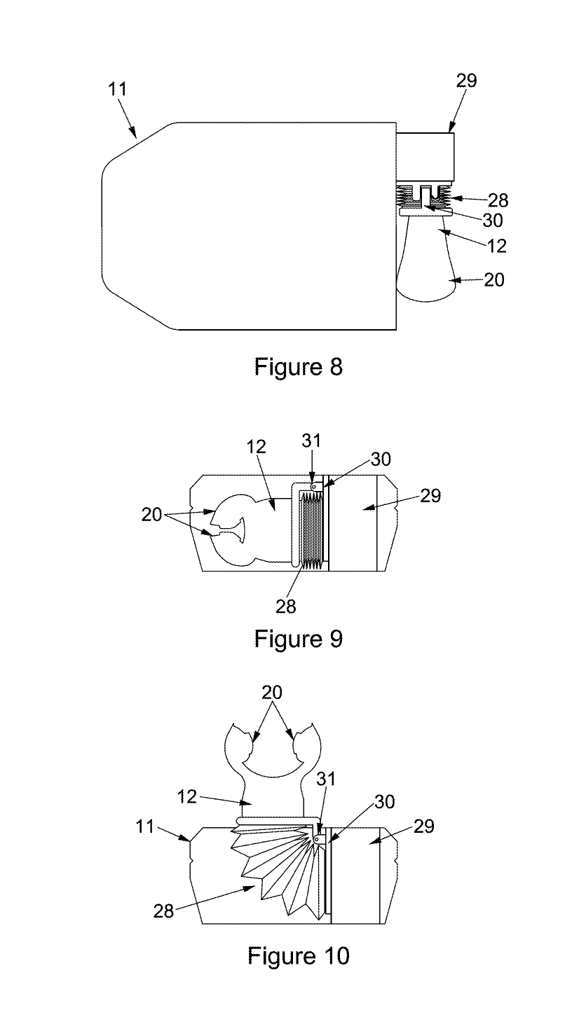

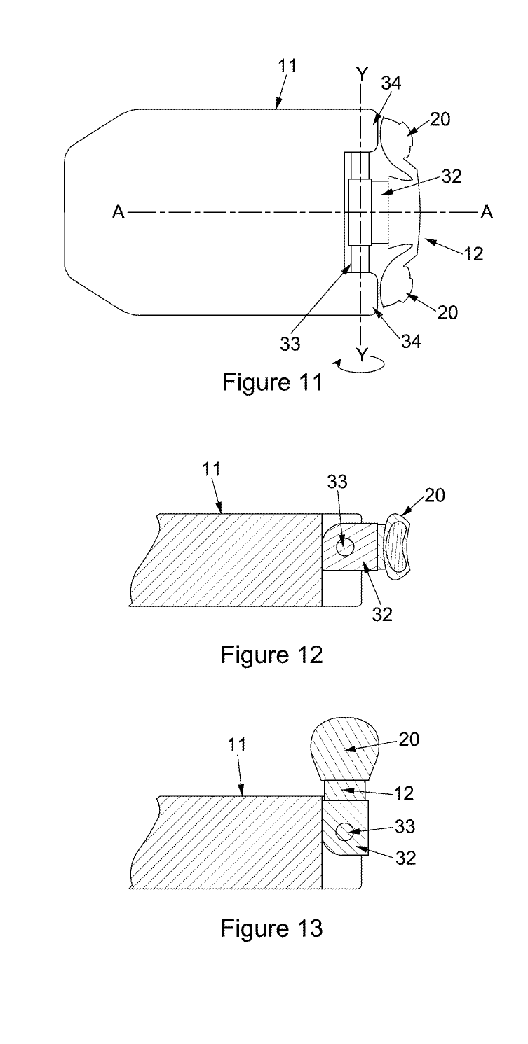

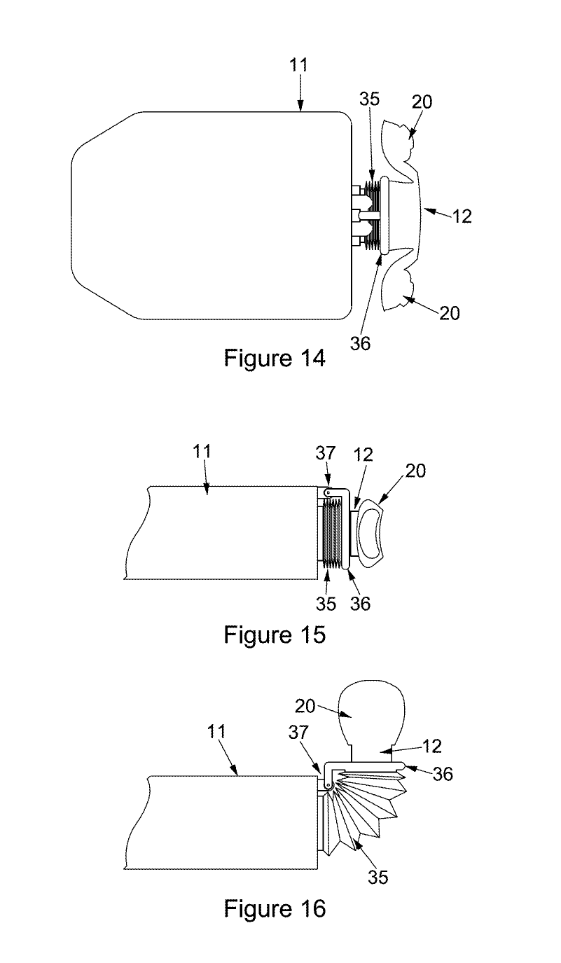

In summary: FIGS. 1 to 3 illustrate a retracting mouthpiece embodiment; FIGS. 4 to 7 illustrate a rotating mouthpiece embodiment; FIGS. 8 to 10 illustrate an embodiment incorporating airtight bellows; FIGS. 11 to 13 illustrate an embodiment incorporating an airtight hollow axle; and FIGS. 14 to 16 illustrate an embodiment incorporating airtight bellows.

### DETAILED DESCRIPTION

In FIG. 1, device 10 consists of filter box assembly 11, which incorporates filter 13 and downstream air channel 14. Mouthpiece 12 is fitted in an airtight manner to moveable backplate 15. Airtight flexible diaphragm 16 provides an airtight seal between moveable backplate 15 and fixed backplate 17, part of the filter box assembly 11, which forms the rear of downstream air channel 14. Flexible diaphragm 16 can be in the form of a sheet of flexible gas-tight material which can be either elastic or non-elastic or can be in the form of flexible bellows, not shown. Spring(s) 18 is/are located between the downstream surface of filler 13 and moveable backplate 15. In the device illustrated a hood 19 is fitted to fixed backplate 17. Hood 19 is worn over the wearer's head to provide protection to the wearer's eyes.

A benefit of the device described above is that downstream air channel 14 can be deeper than the more usual 3-7 mm used in many devices. This greater airflow channel depth ensures a more uniform airflow through the full area of the filter media than in devices with shallower downstream air channels and thus maximizes filter efficiency and capacity and reduces inhalation resistance.

Exhalation valve(s) 21, if fitted, can also be located in the depth of downstream air channel 14 as illustrated in FIG. 2. Exhalation valve(s) 21 so located within the increased depth of downstream air channel 14 can provide a lower exhalation resistance than such valves in conventional devices with shallower downstream air channels.

A further benefit of the invention embodiment described above is that, if used with a hood or visor, such components can be folded against or wrapped around smooth and/or Flat surfaces. This can permit the use of a semi-rigid or rigid visor with enhanced optical quality as compared with a fully flexible hood which, in a device with a fixed mouthpiece, would usually be packed around or against uneven surfaces.

FIG. 3 shows that by compressing spring(s) 18 mouthpiece 12 can be retracted into filter box assembly 11 for packaging.

In the packed position, FIG. 3, mouthpiece 12 has been retracted into downstream air channel 14 by compressing spring(s) 18. In addition, parts 20 of mouthpiece 12, which fit inside the wearer's mouth, have been “folded back” inside the depth of downstream air channel 14. Hood 19 can then be folded and packed against the back of fixed backplate 17 or can be wrapped around filter box assembly 11 and can hold mouthpiece 12 in the packed position. The parts 20 may be foldable parts.

Once hood 19 has been unpacked, spring(s) 18 are free to force moveable backplate 15 and mouthpiece 12 out of downstream air channel 14 into the in-use position and parts 20 of mouthpiece 12 spring into their normal use position, as shown in FIGS. 1 and 2.

The embodiments illustrated in FIGS. 1 to 3 comprise a mouthpiece, which is part of a mouthpiece assembly. In some embodiments, a mouthpiece assembly consists only of (or essentially of) a mouthpiece.

As an alternative embodiment of the invention FIGS. 4-7 illustrate a device in which mouthpiece 12 can be rotated around a fixed point to lie within the depth of filter box assembly 11 in the packed condition and rotated into the in-use position.

FIGS. 5 and 6 illustrate this embodiment with mouthpiece 12 in the in-use position. FIGS. 4 and 7 illustrate the device with mouthpiece 12 in the packed position.

In FIGS. 4-7 mouthpiece 12 is fitted to assembly 22 which is located on one of the shorter sides of filter box assembly 11. Assembly 22 incorporates hollow male threaded section 23 and air channel 26 such that air can flow through male threaded section 23 into mouthpiece 12. Male threaded section 23 screws into matching female threaded section 24 which is incorporated into filter box assembly 11. In this embodiment of the invention filter box assembly 11 also incorporates extended air channel 25 such that air can flow from downstream air channel 14 through air channel 25, through male threaded section 23, through air channel 26 and into mouthpiece 12. To ensure an airtight seal between filter box assembly 11 and assembly 22 a suitable airtight gasket 27 is located between filter box assembly 11 and assembly 22. Assembly 22 may be a mouthpiece assembly, and air channel 25 may be a mouthpiece air channel.

In the packed position, as shown in FIGS. 4 and 7, assembly 22 and mouthpiece 12 lie within the depth of filter box assembly 11, allowing parts 20 of mouthpiece 12, which fit inside the wearer's mouth, to be folded to fit within the depth of filter box assembly 11.

When rotated to the in-use position, FIGS. 5 and 6, assembly 22 and filter box assembly 11 are drawn together by the action of the screw thread, having the effect of compressing airtight gasket 27: thus ensuring a more positive seal. The axis of rotation being about the line X-X in FIG. 4.

An exhalation valve, if fitted, can be incorporated in assembly 22, not shown.

FIGS. 8-16 illustrate further embodiments of the invention.

FIGS. 8-10 illustrate a device in which the airtight connection between mouthpiece 12 and downstream air channel 14 is ensured by airtight bellows 28.

FIGS. 8 and 9 illustrate this embodiment with mouthpiece 12 in the packed pOStiOri. Connector 29 is fixed to filter box assembly 11 and is connected to hinged mouthpiece assembly 30 and mouthpiece 12 by airtight bellows 28. Mouthpiece 12 kes on the short axis of filter box assembly 11 and, if necessary to minimized bulk, parts 20 of mouthpiece 12, which fit inside the wearer's mouth; can be folded to fit within the depth of filter box assembly 11. Assembly 30 may be a mouthpiece assembly.

To bring mouthpiece 12 into the in-use position, FIG. 10, mouthpiece assembly 30 is rotated around pivot point 31. To hold mouthpiece assembly 30 and mouthpiece 12 in the in-use position, a stop, not shown, may be provided. may be provided.

The material(s) from which bellows 28 constructed should be suitable for agents against which the device is intended to be used.

FIGS. 11-13 illustrate an embodiment in which assembly 32 and mouthpiece 12 can be rotated through about 90° so that in the packed position these assemblies lie on the long axis of filter box assembly 11 and in the in-use position rotate to stand proud of filter box assembly 11. Assembly 12 may be a mouthpiece asse

FIG. 11 illustrates this embodiment of the invention in plan view with mouthpiece 12 in the packaged position. FIGS. 12 and 13 show section A-A in side elevation. FIG. 12 showing the mouthpiece assembly 32 in the packed position and FIG. 10 showing the mouthpiece assembly 32 in the in-use position. Assembly 32 is fitted to hoilow axle 33, which is located and suitably connected in an airtight manner to hollow extensions 34, which form an air passage between mouthpiece 12 and downstream air channel 14. Parts 20 of mouthpiece 12, which fit inside the wearer's mouth, can be folded to minimize bulk.

To bring mouthpiece 12 into the in-use position, shown in FIG. 13, mouthpiece 12 and assembly 32 are rotated through about 90°. The axis of rotation being about the line Y-Y in FIG. 11.

FIGS. 14-16 illustrate an alternative arrangement of the embodiment shown in FIGS. 11-13 in which hollow axle 33 and extensions 34 are replaced by suitable airtight bellows 35.

FIGS. 14 and 15 illustrate this embodiment of the invention in plan and side elevation respectively with mouthpiece 12 in the storage position, and parts 20, which fit inside the wearer's mouth, being folded back to reduce overall stored dimensions. Mouthpiece 12 is connected in an airtight manner to downstream air channel 14 by bellows 35.

To bring mouthpiece 12 into the in-use position, shown in FIG. 16, mouthpiece 12 and assembly 36 are rotated through about 90° around pivot point 37. To hold mouthpiece 12 in the in-use position, a stop, not shown, may be provided. Assembly 36 may be a mouthpiece assembly.

The material(s) from which bellows 35 are constructed should be suitable for agents against which the device is intended to be used.

While this invention has been described with reference to the sample embodiments thereof, it will be appreciated by those of ordinary skill in the art that modifications can be made to the structure and elements of the invention without departing from the spirit and scope of the invention as a whole.

What is claimed is:

1. A respiratory protective device comprising:
a filter box assembly; and
a mouthpiece assembly,
wherein the mouthpiece assembly is configured to fluidly connect to the filter box assembly,
wherein the mouthpiece assembly is moveable relative to the filter box assembly between a packed position and an unpacked position, such that in the packed position the mouthpiece assembly is located at least partly within a profile formed by a side of the filter box assembly, thereby reducing the size of the device, and
wherein a majority of the mouthpiece assembly is located within the profile of the filter box assembly when the mouthpiece assembly is in the packed position.

2. The device of claim 1, wherein the mouthpiece assembly comprises a mouthpiece.

3. The device of claim 2, wherein at least a part of the mouthpiece is elastically deformable to minimize the size of the mouthpiece.

4. The device of claim 2, wherein at least a part of the mouthpiece is foldable.

5. The device of claim 1, wherein a minority of the mouthpiece assembly is located within the profile of the filter box assembly when the mouthpiece assembly is in the unpacked position.

6. The device of claim 1, wherein the mouthpiece assembly is at least one of: retractably connected to the filter box assembly and extendibly connected to the filter box assembly.

7. The device of claim 1, wherein the mouthpiece assembly is at least one of rotatably connected to the filter box assembly and pivotally connected to the filter box assembly.

8. The device of claim 1, wherein the mouthpiece assembly is located externally to the filter box assembly and is positioned such that at least a part of the mouthpiece assembly overlaps with a side of the filter box assembly when the mouthpiece assembly is in the packed position.

9. The device of claim 8, wherein the mouthpiece assembly overlaps a side of the filter box assembly that is defined by the height and depth of the filter box assembly. 10, The device of claim 8, wherein the mouthpiece assembly is rotatable relative to the filter box assembly.

11. The device of claim 10, wherein the mouthpiece assembly is rotatably connected to the filter box assembly.

12. The device of claim 10, further comprising a gasket located between the mouthpiece assembly and the filter box assembly, wherein the gasket is configured to provide a hermetic seal between the mouthpiece assembly and the filter box assembly when the mouthpiece assembly is rotated to the unpacked position.

13. The device of claim 8, wherein the mouthpiece assembly is pivotable relative to the filter box assembly.

14. The device of claim 13, wherein the mouthpiece assembly is pivotally connected to the filter box assembly.

15. The device of claim 1, wherein the filter box assembly further comprises a filter fluidly connected to the mouthpiece assembly and configured to permit ingress of air from the atmosphere.

16. The device of claim 15, wherein the filter is a longitudinal filter extending along a longest side of the filter box assembly.

17. The device of claim 15, wherein the filter box assembly further comprises an a channel located between the filter and the mouthpiece assembly, and wherein the air channel is fluidly connected to the filter and the mouthpiece assembly.

18. The device of claim 17, wherein the air channel is a longitudinal air channel extending along a longest side of the filter box assembly, and substantially in parallel with the filter.

19. The device of claim 1, further comprising a hood.

20. The device of claim 19, wherein the hood is connected to the filter box around the mouthpiece assembly.
